(19) United States
(12) Patent Application Publication
(10) Pub. No.: US 2023/0324687 A1
(43) Pub. Date: Oct. 12, 2023

(54) WEARABLE OPTICAL DEVICES

(71) Applicant: Snap Inc., Santa Monica, CA (US)

(72) Inventors: Rory Thomas Alexander Mills, Rochester (GB); Ian Thomas Macken, Rochester (GB)

(21) Appl. No.: 18/021,725

(22) PCT Filed: Aug. 6, 2021
(86) PCT No.: PCT/GB2021/052046

§ 371 Date: Feb. 16, 2023

(30) Foreign Application Priority Data
Aug. 20, 2020 (EP) 20275132.7
Aug. 20, 2020 (GB) 2012987.0

(51) Int. Cl. G02B 27/01

(52) U.S. Cl. CPC G02B 27/0172; G02B 27/0176; G02B 2027/0178; G02B 2027/0154; G02B 2027/0181; G02B 2027/0123

(57) ABSTRACT

Various embodiments of the disclosed subject-matter include a wearable optics device including an adjustment mechanism supportable on a frame adapted to be worn by a user; one or more waveguides in a pre-aligned position relative to the adjustment mechanism; and an optical element moveably attached to the adjustment mechanism to enable the optical element to be moved based on a user preference and to provide an exit pupil for the wearable optics device In various embodiments, the waveguide output is oversized relative to the input region of the optical element. Other devices and apparatuses are also disclosed.

The present invention relates to improvements in or relating to wearable optical devices, particularly but not exclusively to adjustable wearable devices.

Wearable optical devices are common in many walks of life. These include automotive applications, aviation, military applications, engineering, medicine, gaming and any general application for viewing media and the like. Wearable optical devices are often referred to as head mounted displays (HMD) or head worn displays (HWD); the expression ‘HMD’ is used herein to represent HMDs, HWDs and any other wearable optical devices such as, for example, goggles, glasses and hand held devices with viewing capabilities. Most HMD include two eye pieces, one for each eye.

An example HMD 100 is illustrated in FIG. 1. HMDs, such as HMD 100, are wearable by a user by means of an appropriate support 102. The support includes one or more optical elements 104 which can be viewed by one or both eyes of the user. Although not shown in detail, the optical elements 104 include a substantially transparent display medium. The user is able to view the exterior environment through the optical elements 104. The user is also able to view images relayed to the eye of the user in use via the HMD.

In conventional systems, images are relayed to the eye of the user in use using lens trains or folded optical designs. Lens trains or folded optical designs are incorporated into the HMD 100. Traditionally, lens trains or folded optical designs are incorporated within the support 102 of the HMD 100.

Traditional optical lens trains are linear and non-folded for simplicity. Multiple elements are usually used to achieve the performance required. For this reason, they are not particularly suitable for use in modern HMDs that are required to be compact, lightweight, and optimised for anthropometric data.

Traditional folded optical designs can be more compact, but can also introduce light loss mechanisms, reducing system efficiency. One of the simplest folded optical designs consists of an optical arrangement 200 as shown in FIG. 2.

The optical arrangement 200 comprises a beamsplitter 202 and a spherical combiner 204. In use, images are directed from a display source 206 or relay lens onto the beamsplitter 202. The beamsplitter 202 partially reflects the images onto the concave surface of the spherical combiner 204. The spherical combiner 204 reflects a collimated exit pupil through the beamsplitter 202 towards the user's eye 208.

HMDs are used for many applications as indicated above, however there is a continual problem encountered in their use. This is that they tend suffer from alignment problems with respect to aligning the viewable output to the human eye. This makes viewing less comfortable or more difficult than would be desired. When designing an HMD, anthropometric data (relating to skull dimensions and body proportions) are taken into consideration. This helps with the viewing comfort but only to a limited extent. One main problem is that users each have a different interpupillary distance (IPD). As a result, the ideal positions of the eyepieces from one user to the next would be different. Achieving a stable means of adjusting the IPD for individual users has proved difficult.

In order to accommodate different IPDs a number of proposals have been made. For example, use of a large eye box enables a greater number of IPDs to be accommodated. However, this leads to a necessity to create a large exit pupil and a bigger optical system adding weight to the HMD, which is undesirable. In addition, luminance and optical performance can be negatively impacted by an increased size exit pupil.

Some HMD/HWD's utilise IPD adjustment to move the optical system about a 3D volume to align the exit pupil to a user's eye. One issue in moving the whole optical system, especially in a wearable/smaller form factor system, is compacting the mechanics to allow for the movement and maintaining alignment both between the eye and the optics, and in a binocular system alignment between two binocular optics. Introducing such mechanics also adds mass, adds complexity and introduces additional points of failure. However, adjustment may allow for a smaller optical system as the system exit pupil can be reduced due to the fact it can be moved around in space to create an eyebox. Within a fixed frame waveguide display it is preferable to leave the waveguides in situ once they have been built into a unit, specifically with a binocular system it is preferable to leave the two waveguides in situ and aligned binocularly such that they are aligned angularly and positionally with respect to the nominal design eye. Any movement of the optics can lead to misalignment and can cause eyestrain to the user with only very minor optical changes. Therefore, IPD adjustment mechanisms become difficult to implement as the waveguides (the primary elements that generate the eyebox of the HMD/HWD) are fixed in place and thus immovable.

FIG. 3 is an illustration showing the problem regarding differing IPDs. The figure shows the eye 304 of the user which has wide IPD. Collimator optics 300 are in a nominal position that does not align the waveguide output 304 600b to this IPD position. As a result, the user cannot see display. The problem can manifest itself with other IPD differences such as a narrow IPD, different level of the eyes, etc.

Accordingly, one object of the present invention is to overcome the problems of existing HMDs.

A further object is to provide a HMD or the like in which different IPDs can be accommodated in an adaptable system which is lightweight and does not suffered from the disadvantages of known systems.

### SUMMARY

### Aspects and Embodiments of the Invention are Defined According to the Appended Claims.

According to an aspect of the present invention there is provided a

### DESCRIPTION OF THE DRAWINGS

FIG. 1 is a diagram showing a representation of a head-mounted display.

FIG. 2 is a diagram showing a cross-sectional diagram of a conventional optical arrangement.

FIG. 3 is a diagram showing the problem associated with differing IPDs.

FIG. 4 is a diagram showing a cross-sectional diagram of a folded optical arrangement, according to an embodiment of the present invention.

FIG. 5 is a schematic diagram of a binocular system comprising two collimating elements, according to an embodiment of the invention.

FIG. 6 is diagram showing a first example of a binocular system comprising two collimating elements, according to an embodiment of the present invention.

FIG. 7 is diagram showing a second example of a binocular system comprising two collimating elements, according to an embodiment of the present invention.

FIG. 8 is a diagram showing different positions for the collimating elements for different users, according to an embodiment of the present invention.

FIG. 9 is a diagram showing a slab configuration of the elements of the optics device, according to an embodiment of the present invention.

FIG. 10 is a flow chart showing the steps for adjusting the setting of the optical device, according to an embodiment of the present invention.

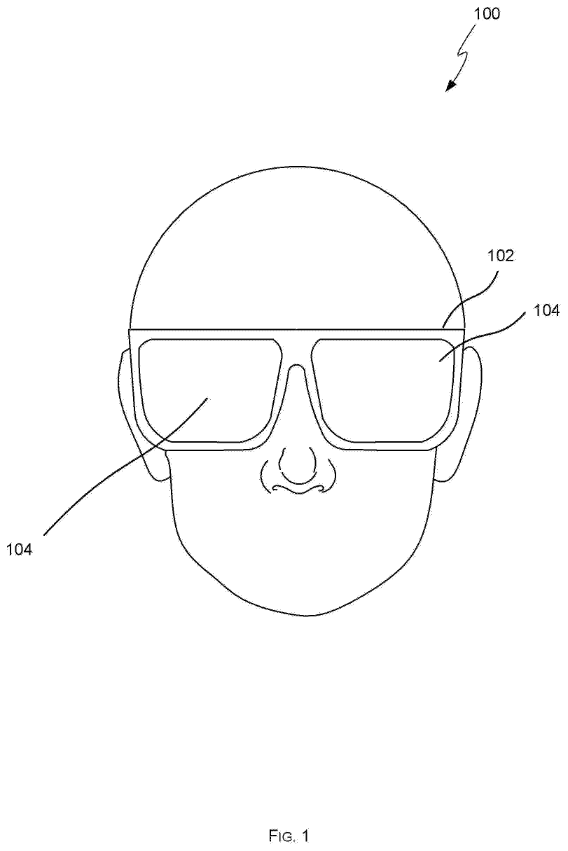

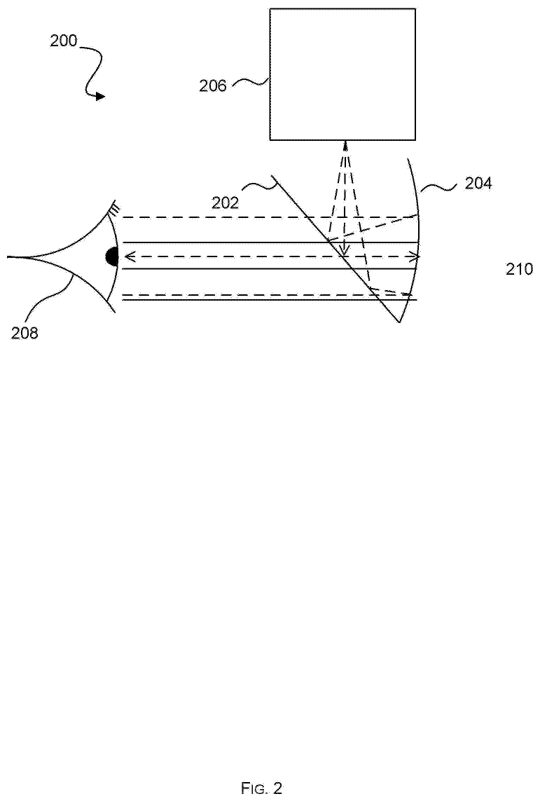

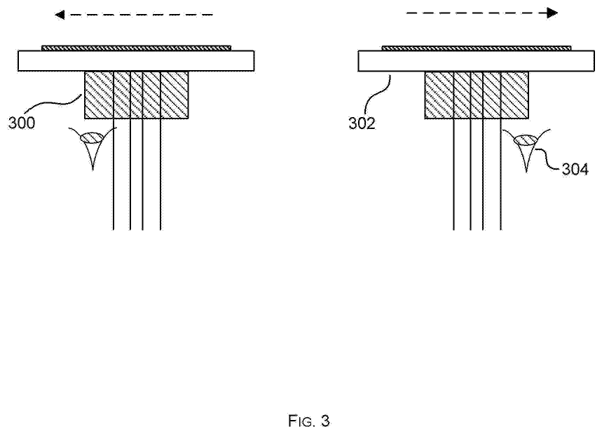

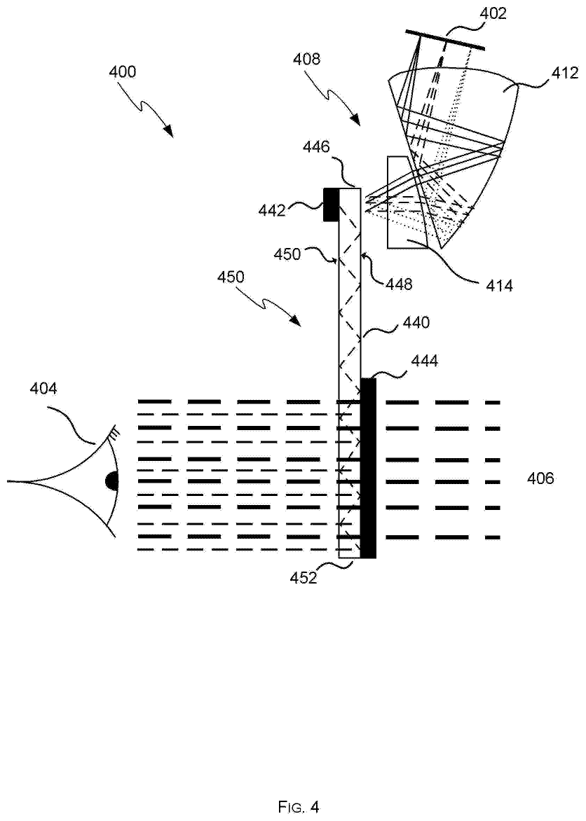

### DESCRIPTION OF THE INVENTION

In general, the present invention relates to improvement in or relating to wearable optics devices such as HMDs where the problems associated with variable IPD of different users are addressed.

The present invention relates to a novel technique for providing an adjustable, modular HMD or associated kit of parts in which the positions of the optics in an HMD can be varied to suit the IPD and other anthropometric characteristics of each user.

FIG. 4 shows a cross-sectional view of a folded optical arrangement 400 according to an embodiment of the invention. FIG. 4 shows the path of light rays through the optical arrangement 400 from an image plane 402 to a user's eye 404, and from the exterior environment 406 to the user's eye 404.

The optical arrangement 400 comprises a collimating element 408, also described as collimating optics, and a pupil expanding element 450, also described as an exit pupil expander. Light forming an image from the image plane 402 is directed towards the collimating element 408. The collimating element 408 receives the light forming the image. The light is collimated by the collimating element 408 and the collimated light is output from the collimating element 408. The collimated light is incident on the input region of the pupil expanding element or waveguide optic 450 and the pupil expanding element 450 transmits the collimated light towards the location of the user's eye 404. The pupil expanding element 450 receives the light over a first input area and effectively expands the exit pupil output from the collimating element 408 so that light leaves the pupil expanding element 450 towards the eye in use over a larger, second output area. As a result, the collimating element 408 can be reduced in size to be highly compact, by generating a small exit pupil, whilst the system still maintains a large exit pupil, via the exit pupil expanding element, which is directed towards the user's eye 404 for displaying the image. An optically absorbing element (not shown) may be placed behind the input region of the pupil expander to absorb any light not coupled into the pupil expander.

For the purposes of the figures, it will be assumed that the user's eye 404 is in the location shown, and references to the user's eye should be interpreted to mean that the typical use case is being described. However, it will be appreciated that the user's eye is not required for the invention to operate according to the principles set out herein. The optical arrangements described below ultimately generate exit pupils in the direction of an assumed position of the user's eye when the device is in use, regardless of where the user's eye actually is. Furthermore, the solid ray, dashed ray and dotted ray indicate the field of view of the optical arrangement. It should also be appreciated that the figures are illustrative, and do not show the exact ray paths through the optical arrangements.

The HMD can be of any appropriate type including goggles, glasses, a helmet or helmet visor, or in the form of a handheld device which can be brought in front of the eyes. Ideally, the device is portable or adapted to be portable by means of the support. Although not shown in detail the support may include a support adapted to support the optical elements in front of the eye. The support may include: frames; side arms and supports for goggles and glasses; a helmet or visor; a headband; a neck or shoulder worn support; a gaming headset; or any other support that could be worn to hold the optical elements in the desired position.

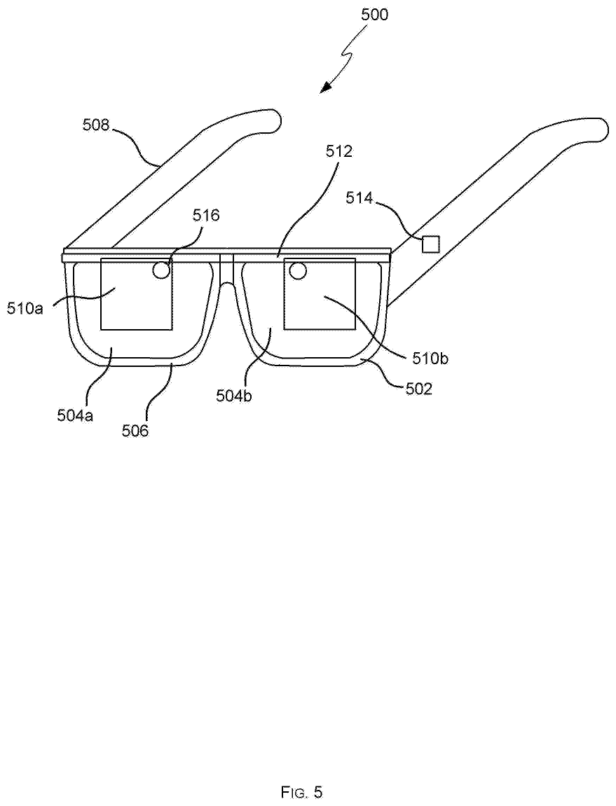

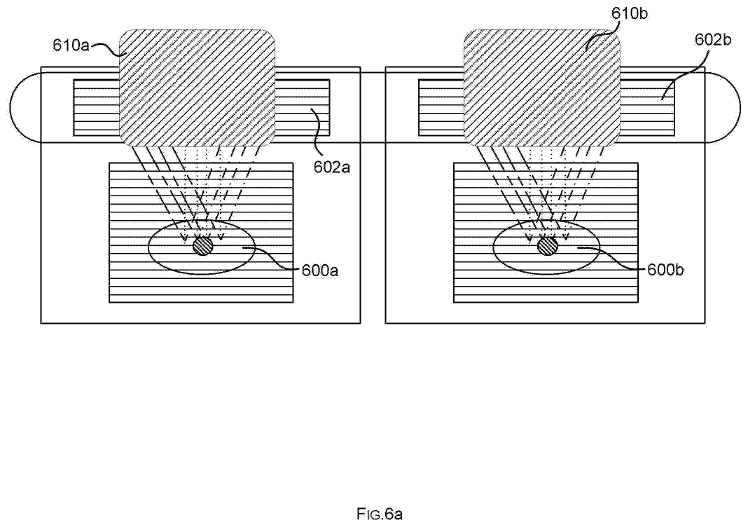

Referring to FIG. 5. The optical element 500 includes a frame 502 two eyepieces 504a and 504b held together by a bridging element 506. The frame is connected to two arms 508 which support the optical device on the user's head. The eyepieces each include a display element 510a and 510b which relay an image to the eye of the user in use. The display element includes, for example, a collimating element, waveguide, a lens system, a prism, or other optical components. In FIG. 5 the device is shown as binocular, but it is possible that the device could be monocular with one of the display media being replaced with a blank element. The optical elements may be adapted for use in the non-optical domain. It will be appreciated therefore that optical is not limited herein to mean visible optical frequencies and may include non-visible frequencies.

The two eyepieces are separated by a bridging element 506. The bridging element may be a band having a combination of a different curvature and a different length. The bridging element may have a specific shape to position or orient the eyepieces in a predetermined location. The display element may be supported on an adjustment mechanism 512, typically something like a slide rail, with user adjustment. This mechanism allows the unit to slide across the input region of the waveguide optic, therefore moving the exit pupil generated by the display system in line with the user's eye. In some cases, nonsymmetric alignment may be required to cater for non-symmetric IPDs. In addition, the display elements may be made to tilt to facilitate different fields of view (FOV) and different levels of overlapping the FOV of each eye. Other types of movement can be enabled to ensure a full range of movement to adapt the HMD to the different viewing needs of each user.

Typically, on moving, the display elements the system may become uncalibrated or otherwise optically altered in a detrimental way. In order to compensate for this the present invention includes a control system shown generally at 514 which can recalibrate or otherwise adjust various setting on the fly. A mini gyroscope 516 or equivalent monitoring device is located on each display element. This measures the exact position of the display elements relative to each other and provides an instantaneous correction of any optical aberrations brought on by moving the display element or elements.

The gyroscope or IMU, which when mounted to each display element, reports angular offset to the display control system. By knowing the amount of angular offset (off normal) after adjustment of each display element, the system can compensate and/or re-calibrate for binocular alignment by shifting the displays digitally to realign them between the two eyes. Typically, if a binocular display has errors caused by binocular disparity (caused by relative misalignments) it may cause discomfort and fatigue in the user. This is typically due to residual errors in boresight, convergence and or divergence.

The control system is variable depending on the use of the HMD. The control unit may be in situ or remote from the HMD. The control device may include a communications module for communicating with the optical elements and with other modules either on the HMD or remote therefrom. The communications may be wireless and/or wired. The control module may include different modules for carrying out different functions. These functions are not limited in any way but may include imaging, tracking, scene generation, processing, storage, power supply, audio etc.

In the present invention, each display element comprises a compact guide element 510a and 510b which can be used to generate the images for injection into the waveguide optics. Accordingly, the waveguide optics can all be pre-aligned and bonded into the frame in an appropriate location. This will mean that the calibration and settings of the waveguide portions of the system will be unaltered in normal use of the system.

The waveguides may be oversized, to ensure that the pupil formed by the output region of the waveguides covers an area matching that of the IPD range of the target population. In other words, the waveguide is configured to be big enough to substantially overlap the positions of the display element (at the farthest and nearest extremes) for respective IPD requirements. The compact collimating element is then designed to generate only enough exit pupil to cover an eye motion box of a single user (e.g. calculated by taking into account the pupil size and eyeball rotation corresponding to the FOV of the display and typically being in the region of 5 mm diameter), thus significantly reducing the size and/or volume of the display element. The waveguide output is likely to only exceed the dimensions of the input in 1 dimension (the pupil expanding direction). The input region of the waveguide is likely to be wider than the output region.

The collimating elements can then be arranged above the waveguides, adjacent to an input region on the waveguide, and along the moveable adjustment mechanism which allows the collimating element to be moved in any required manner. For example, the collimating elements can then be adjusted along an axis in plane with the variation of IPD of a target user base. With the present invention, small collimating elements can be used with fixed and/or pre-aligned waveguide optics to be adjustable across a broad range of users thus maintaining a small optical system with large IPD coverage between users and minimising the amount of moving elements for housing within a single overall frame.

The waveguide may be implemented using different technologies. For example, the waveguide may be facilitated by diffractive, holographic and/or reflective components.

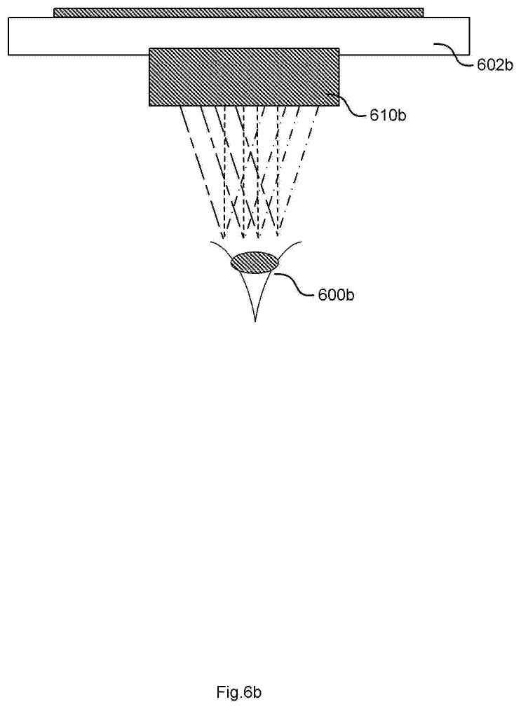

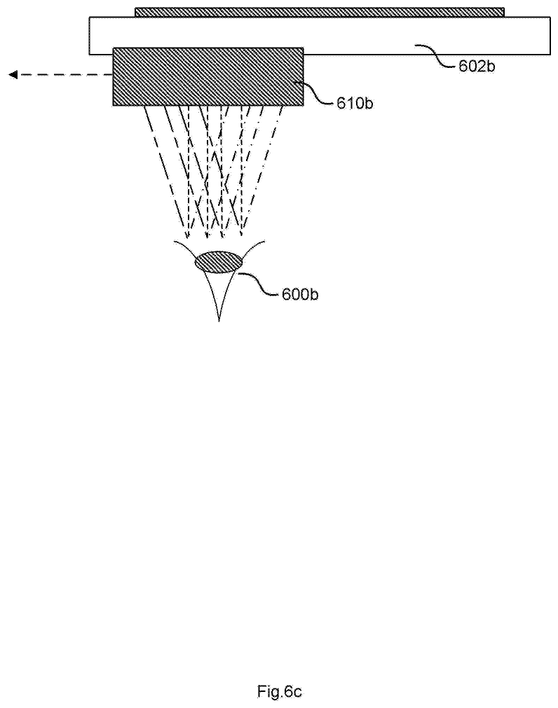

In this system the collimating elements may be paired with a flat panel display source. This optic and display panel can be arranged as a single unit, being bonded together. This unit may be separate from the waveguide element. In a binocular system, two collimating elements will be used (one per eye) arranged over the waveguide optics. The waveguide optics may comprise one waveguide (602a and (602b) per eye 600a and 600b as shown in FIG. 6 for respective collimating elements 610a and 610b. FIGS. 6b and 6c show respective top and side views for one eye 600b.

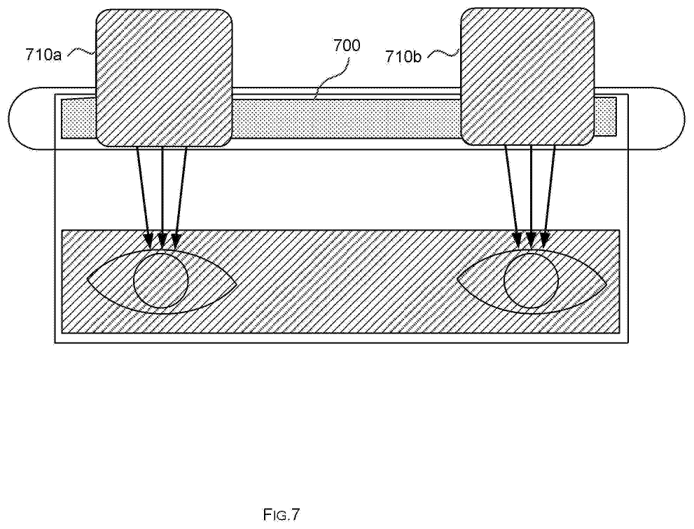

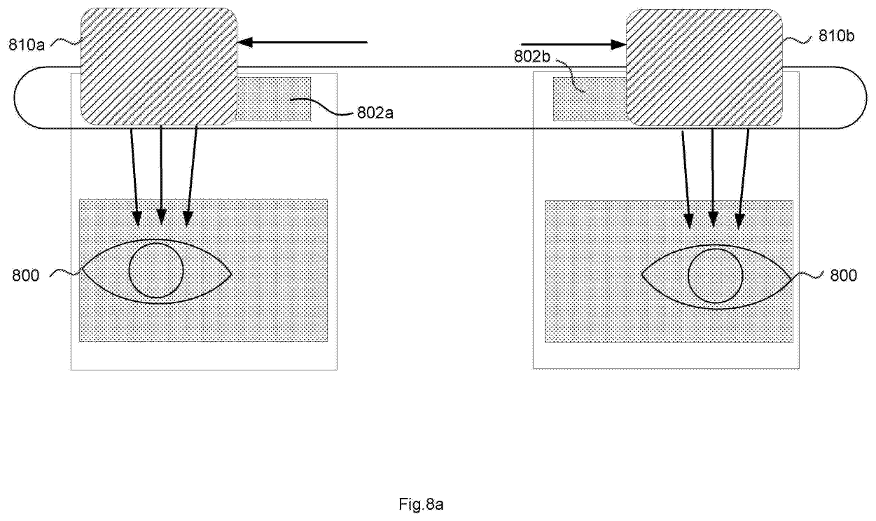

In an alternative, the waveguide optics may comprise a single waveguide 700 that is arranged to cover both eyes and used for both collimating elements 710a and 710b, as shown in FIG. 7. It should be noted the goal is to ensure the formation of an appropriate exit pupil output for a given FOV that it is aligned to the eye. As a result, the users eye needs to be within the exit pupil or eye motion box to see the full FOV.

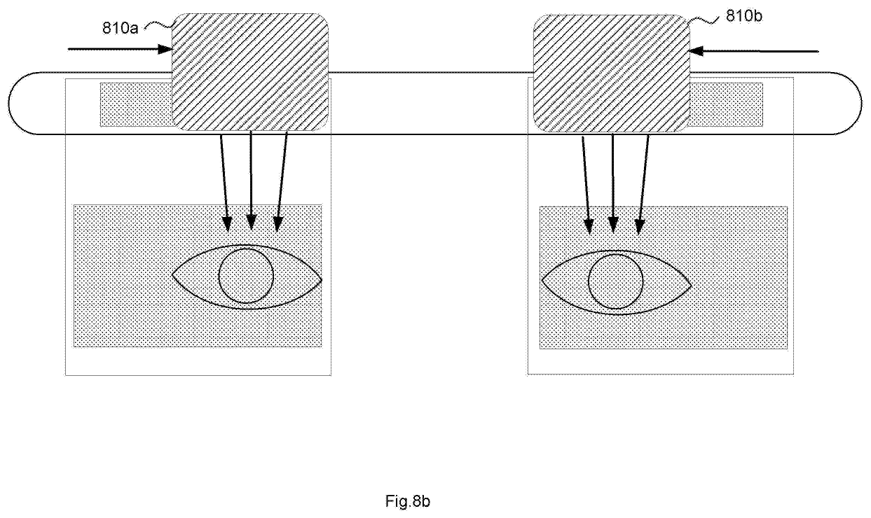

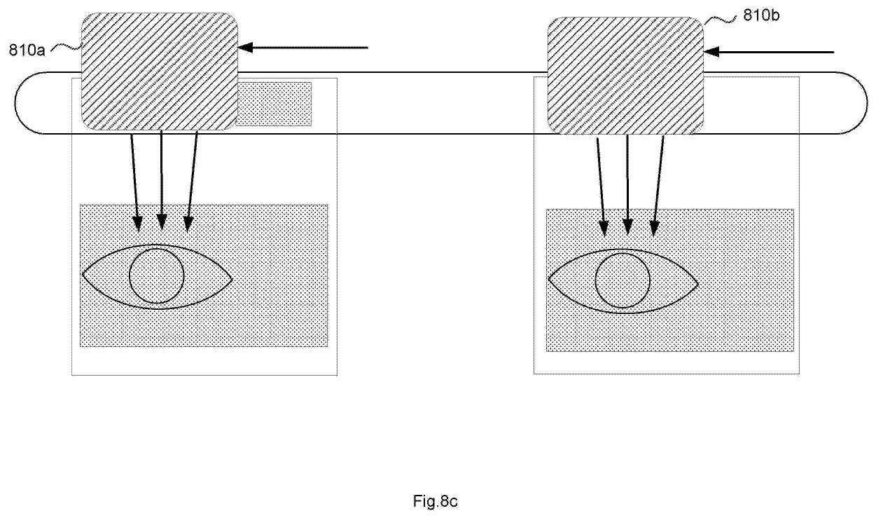

FIG. 8 shows three arrangements of the collimating elements 810a and 810b arranged for different eyes 800. The collimating element may be moved by the user to the most appropriate position, examples being shown in FIGS. 8a, 8b and 8c. In some embodiments the movement may be relative to the waveguide.

The mechanism for enabling movement of the collimating elements relative to one another can include a slider; a screw mechanism; a lever, any other mechanical mechanism or an electronic control system which automatically adjust the positions of the elements. The electronic movement system can cause the optical elements to automatically move to a required position. This could be based on a user profile or settings detected by the system to align the optical elements based on a user's eye positions or other user related or environmental conditions. The automatic adjustment may be implemented by a motor to cause the optical element to move relative to the adjustment mechanism to one or more predetermined positions. The automatic adjustment mechanism may be connected to a control system. The control system can cause the display elements to move to know of positions based on a user profile or commonly used IPD or FOV settings. In addition, the main movement could be automatic and the final fine tuning of the display elements could be manual or vice versa.

As can be seen from the different arrangements the separation of the centre of the pupil is different from one arrangement to the next. This is due to the fact that the respective users each have, for example, a different interpupillary distance (IPD). In general, IPD ranges from about 55 mm to about 75 mm. IPD is one anthropometric characteristic that is measured to determine where to locate eyepieces for a particular user. This is not the only anthropometric characteristic or constraint which could be used, others include: eye spacing and height, pupil size, head breadth, nose position, nose size, etc. In addition, the position of the eye of a user may be sunken, bulging or otherwise variable in natures. Occasionally, users even have eyes at different heights relative to one another or be cross-eyed. Further nose shape and width can have a significant influence. Each of the above-mentioned differences affects the required location of the active optical area for each pupil of each user. If the pupil is not correctly oriented relative to the active area portions of the display image may not be visible or visual artefacts may present themselves.

To overcome the different positions and orientations of users' pupils the present invention provides a sliding or otherwise moving collimator across the input region as shown in FIG. 7 that moves the exit pupil output by the waveguide in the horizontal axis (the same axis in which IPD will vary between users). Therefore, a large population of users with varying IPD are able to use the display through personalized adjustment, but the display optics remain small and compact as they are only ever generating a limited exit pupil size rather than a large exit pupil intended to cover multiple users.

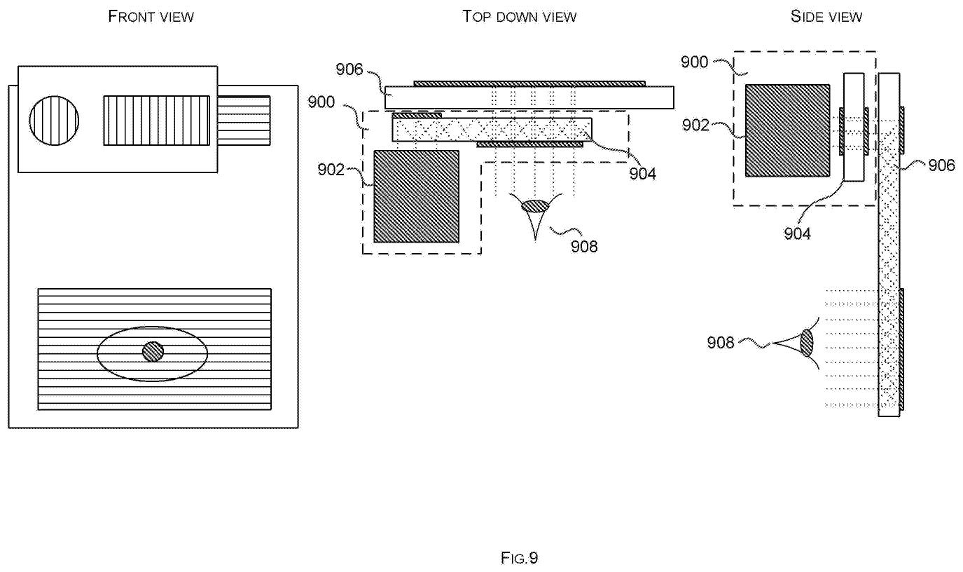

FIG. 9 shows a slab configuration of an optical device of the present invention in which a 2-dimensional exit pupil expander can be used. Optical group 900 may replace the collimating element in this alternative arrangement. The optical group 900 has the same level of adjustment as discussed for the collimating element, however it includes a collimating element 902 and a horizontal pupil expander 904. The collimating element may comprise a series of lenses. The horizontal pupil expander 904 is sized to produce the required exit pupil at the eye 908 for a given eye position also referred to as an IPD setting. The horizontal pupil expander 904 further reduces the required size of the collimating element 902 when compared to previous examples and thus allows for a greater degree of freedom regarding optical layout as the collimating element 902 can be offset from the eye 908. A vertical pupil expander 906 is also provided and is operated in a similar manner to other pupil expanders described herein.

Throughout the exit pupil expanders are shown as flat or planar structures. However, they could be other shapes and sizes than those shown. For example, a curved exit pupil expander.

The diagrams all represent the exit pupil as a one-dimensional exit pupil expander. It is noted that the exit pupil could equally be a two-dimensional exit pupil expander. Similarly, as shown the exit pupil is planar or flat and could instead be curved or shaped in a different manner.

As previously mentioned, the collimating elements may be titled from one angular orientation to another. This has the effect that the HMD can give rise to a wider perceived field of view (FOV) than if the eyepieces were not angularly displaced. As each eyepiece is orientated off the nominal axial display path, the perceived display FOV will now comprise of a central stereoscopic region where the FOV from each eyepiece overlaps and a FOV region outside of this central region where the FOV from each eyepiece does not overlap. This will typically result in a wider binocular FOV comprising the central FOV region and FOV at the edges of the central region; this will be perceived as a wider FOV by the user.

The present invention is aiming to provide a flexible and adjustable HMD which can be adapted for use with different users by a combination of user adjustment of the collimating elements and optical compensation via the control system.

The optical compensation provided by the control system will now be described. The control system will provide data used to alter the image generated on the display device for each eye. In the case of stereoscopic displays, the users IPD is required to render stereoscopic images which accurately correspond to apparent image depths in the real world. Tracking the position of the collimating optics could be measured (for example by using a miniature gyroscope or some other positional measurement device). Once an adjustment has been made to account for a new users IPD can then be used in the generation of the images. Angular offset in the position of the collimating optics either due to intentional offset (i.e. to create a larger FOV), or due to mechanical tolerance in the adjustment mechanism, could also be measured using for example the miniature gyroscope. The measured offset data can then be used by the control system to calculate an adjustment required to the generated images in order to maintain the alignment of images to be presented to the left and right eyes of the user. This would help to ensure display accuracy and reduce user eye strain.

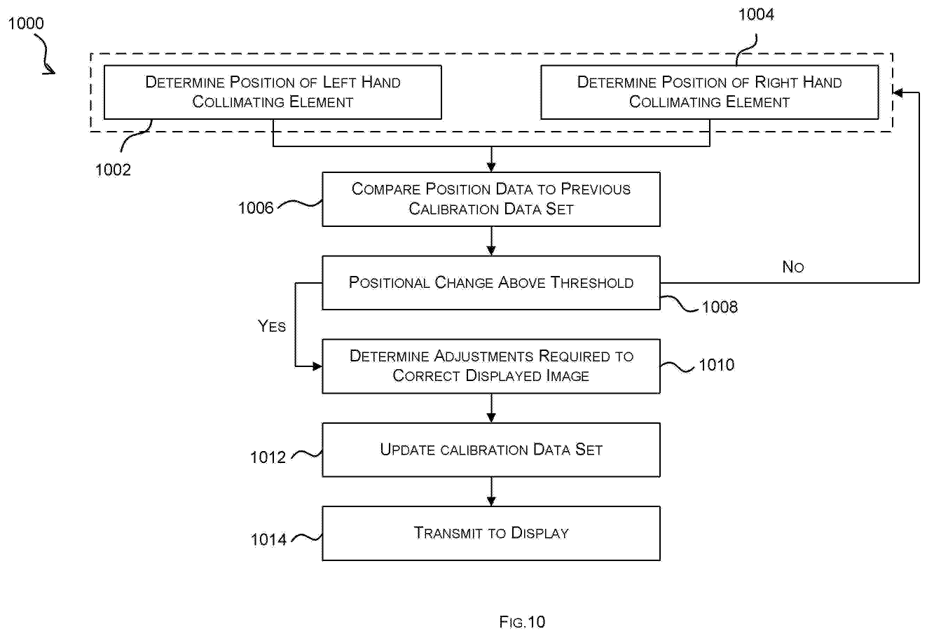

FIG. 10 shows an example of a simple flow diagram 1000 which demonstrates the steps carried out by the control system in use. In a first instance the position of the left- and right-hand collimating elements is determined 1002, 1004. In step 1006, the position of each collimating element is compared to previous calibration data, if available. If this is a first time use for a user, calibration data may be collected based on the user preferences, eye positions, etc. In step 1008 if the comparison identifies a positional change over a predetermined threshold (yes), the process continues. If not, the process returns to identifying the position of the collimating elements anew. If yes at step 1010, the control system determines an adjustment required for the displayed image. At step 1012 the calibration data is updated to reflect the new adjustments. The image is then transmitted to the display at step 1014.

The adjustments made to the optical device can be made by the user based on data supplied by the control system. As an alternative, the eyepieces may be moved automatically by use of a motor or other appropriate device associated with the optical device. In some situations, known user profiles could be stored such that the optical device automatically adjusts based on a user profile.

It should be noted that the description relates to a head worn device, however it could be equally well used to other optical display systems. For example, the optical system could be mounted on a fixed frame and form part of for example a Heads-up display (HUD) of a 3D cinema display or any other appropriate optical device. In the case of such a device the implementation would comprise a single large waveguide and an exit pupil directed towards the eye or eyes of the user or users.

The waveguides enable exit pupil expansion, the waveguide accepts a small input pupil and expands it to a larger exit pupil. The images show this operation in the vertical axis; therefore, the design allows for a large vertical eyebox which means if the display slips up or down on the head the user can still see the display without adjustment. By minimising the vertical size of the input pupil, the collimating optic can also be made small in the vertical axis.

The waveguide is designed to be much larger than the respective exit pupil generated, to allow for the horizontal shift. The horizontal shift is to cater for horizontal alignment of the exit pupil to the user's eye. Since in the 1D exit pupil expander case there is no horizontal exit pupil expansion, the size of the horizontal exit pupil is equal to the size of the horizontal input pupil. To cater for a large population, this would normally make this large in size meaning a large collimating optic. By introducing the adjustment mechanism, the size of the horizontal exit pupil is reduced for population coverage and the collimating optic can also be made small in the horizontal axis.

Combining these two advantages you can design an optical system that has large population coverage in both horizontal (through adjustment) and vertical (through waveguide expansion) axes, whilst maintaining a small optic.

An HMD is a relatively expensive piece of equipment and as such it is undesirable to have more than are needed. By providing an adaptable system in accordance with present invention a single HMD is easily adaptable to all users without having to have a device for each user. In addition, as the configuration is adapted to the IPD of each user by moving a relatively small collimating element to a required position thereby reducing the size and weight of the optics.

As will be appreciated the present invention relates to an adjustable wearable optic device such as an HMD. It could equally apply to different devices, including but not limited to HWD and other optical devices.

By way of example this technique could be applied to heads up displays (HUDs) as part of a pupil steering system. In this case the adjustment mechanism would be associated with the optical device and allow movement of optical elements to align with the user presences. The overall system for achieving pupil steering in the HUD is likely to be more complex as the users' head can move in relation the waveguide and optics device and may need to include pupil tracking systems to ensure correct alignment.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality. In the claims, the term ‘comprising’ or “including” does not exclude the presence of other elements.

1. An optics device comprising:
at least one waveguide supportable on a frame to be positionable relative to a user, the at least one waveguide having an input region and an output region, the output region to provide an exit pupil for the optics device directable to an eye of the user;
an optical element configured to deliver light to the input region of the at least one waveguide over a first input area thereof, the output region and the input region of the at least one waveguide being oversized relative to the first input area,
the optical element being moveably attached to an adjustment mechanism that is supportable on the frame to enable the optical element to be moved relative to the at least one waveguide so as to allow the exit pupil of the at least one waveguide to be moved relative to the frame, so as to be in line with the eye of the user.

2. The optics device of claim 1, wherein the optical device comprises two optical elements, with one optical element for each eye of the user.

3. The optics device of claim 1, further comprising a control system providing optical compensation to the optical element caused by the movement thereof.

4. The optics device of claim 1, wherein the optical element is a collimating element.

5. The optics device of claim 4, Therein the collimating element includes a display.

6. The optics device of claim 1, wherein the optical element is adapted to be moved in a horizontal direction to adapt to interpupillary distance of the user.

7. The optics device of claim 1, wherein the optical element is adapted to be angularly displaceable to create a wider field of view for display.

8. The optics device of claim 1, wherein the at least one waveguide comprises two sections, one for each eye.

9. The optics device of claim 1, wherein the adjustment mechanism comprises a slider on which the optical element is moveably attached.

10. The optics device of claim 1, wherein the adjustment mechanism comprises a tilting mechanism to change the angular position of the optical element.

11. The optics device of claim 1, wherein the optical elements are automatically adjusted relative to the adjustment mechanism to position the optical elements at one or more predetermined positions.

12. The optics device of claim 11, wherein the one or more predetermined positions are based on a stored user profile.

13. The optics device of claim 1, wherein the optical element includes at least one of an active optical element and an inactive optical element.

14. The optics device of claim 1, wherein the frame is adapted to be worn by the user.

15. The optics device of claim 1, further comprising at least one of a frame; side arms and supports for goggles or glasses; a helmet or visor; a headband; a neck or shoulder worn support; and a headset.

16. The optics device of claim 1, wherein the optics device is in the form of a head mounted display.

17. The optics device in claim 1, wherein the optics device is in the form of a head worn display.

18. The optics device in claim 1, wherein the optics device is in the form of one of a heads-up display and a 3D camera display.

19. (canceled)

20. An optics device comprising:
a single waveguide supportable on a frame and arranged to cover both eyes of a user, the single waveguide having an input region and an output region, the output region to provide exit pupils for the optics device respectively directable to both eyes of the user;
two collimating elements, one for each of the eyes of the user, coupled to the single waveguide, to ensure formation of exit pupil outputs for a given field-of-view such that the exit pupils outputs are aligned to each of the eyes of the user, respectively, each of the two collimating elements being moveably attached to an adjustment mechanism that is supportable on the frame to enable each of the two collimating elements to be moved respectively in line with each of the eves of the user.

21. The optics device of claim 20, further comprising a control system to providing optical compensation to the two collimating elements caused by the movement thereof.

22. The optics device of claim 20, wherein the two collimating elements include a display.

23. The optics device of claim 20, wherein the two collimating elements are adapted to be moved in a horizontal direction to adapt to an interpupillary distance of the user.

24. The optics device of claim 20, wherein the adjustment mechanism further comprises a tilting mechanism to change the angular position of the optical element.

25. The optics device of claim 20, wherein the two collimating elements are automatically adjusted by the adjustment mechanism to position each of the two collimating elements at one or more predetermined positions.

26. The optics device of claim 25, wherein the one or more predetermined positions are based on a stored user profile.
